(19) United States
(12) Patent Application Publication
(10) Pub. No.: US 2008/0084063 A1
(43) Pub. Date: Apr. 10, 2008

(54) Drum and pump connector

(76) Inventor: William H. Hamilton, Cincinnati, OH (US)

Correspondence Address: Mark F. Smith, 905 Ohio Pike, Cincinnati, OH, 45245, US

(21) Appl. No.: 11/973,829

(22) Filed: Oct. 10, 2007

Related U.S. Application Data
(60) Provisional application No. 60/850,696, filed on Oct. 10, 2006.

(51) Int. Cl. F16L 5/00

(52) U.S. Cl. 285/219

(57) ABSTRACT

A drum and pump connector for attaching a pump having a cap with internal threads to a drum having a bung hole with internal threads, the drum and pump connector comprising a first cylindrical body and a second cylindrical body, said first cylindrical body having a threaded outer surface sized and adapted to mate with the internal threads of the cap; and the second cylindrical body having a threaded outer surface sized and adapted to mate with the internal threads of the bung hole.

This application claims the benefit of U.S. Provisional Patent Application No. 60/850,696, filed Oct. 10, 2006.

### BACKGROUND OF THE INVENTION

This invention relates to a drum and pump connector and, more particularly, to a drum and pump connector, such as for use with a conventional 55-gallon drum, that permits a pump assembly typically used to pump liquid out of a drum, to be easily attached and removed from the drum.

In many industrial environments, metal or plastic drums, such as conventional 55-gallon drums, used to store liquids are placed in a vertical position for dispensing the liquid contained therein. Typically, such drums are provided with a bung hole which is sealed by a bung plug. Liquid contained in the drum can be dispensed by either by removing the bung plug and rotating the drum to pour the liquid out through the bung hole or by placing a pump having an intake extending through the bung hole and into the liquid which then operates to pump the liquid out of the drum.

Unfortunately, it is often inconvenient or impractical to rotate a drum into a more horizontal position for dispensing the liquid contained therein. In addition, since bung holes are generally positioned radially in from the edge of the drum, the liquid being dispensed will stop flowing when level of the liquid reaches the edge of the bung hole. Thus, drums are often discarded with unused liquid remaining in the drum. A problem associated with dispensing liquid from a vertically positioned drum is that the pump is not attached to the drum and often must be held in position during the pumping process. Further, no seal is formed between the pump and the drum thereby permitting vapors to escape into the atmosphere which can be unpleasant, dangerous, resulting in waste, and can result in a change in the composition and/or properties of the liquid contained in the drum.

Accordingly, what is needed is a drum and pump connector that can be easily installed on a conventional drum, that permits a pump assembly to be mounted thereon during use and can be easily removed allowing the drum and pump connector to be capped until the pump assembly is reattached, and provides a seal between the drum and the pump assembly.

### SUMMARY OF THE INVENTION

This invention is directed to a drum and pump connector effective for attaching to a convention drum, such as a 30 gallon or a 55 gallon drum, and for securing a pump assembly for use in discharging liquid contained in the drum. In a preferred embodiment of the invention the drum and pump connector is attached to the drum with a threaded connection. In another preferred embodiment of the invention the drum and pump connector is attached to a pump assembly with a threaded connection.

In a preferred embodiment of the invention the drum and pump connector for attaching a pump having a cap with internal threads to a drum having a bung hole with internal threads, the drum and pump connector comprises a first cylindrical body and a second cylindrical body; the first cylindrical body having a threaded outer surface sized and adapted to mate with the internal threads of the cap and the second cylindrical body having a threaded outer surface sized and adapted to mate with the internal threads of the bung hole.

In another preferred embodiment of the invention the drum and pump connector further comprises a drum size adapter effective for permitting the drum and pump connector to be easily adapted to mate with a variety of drums having different size and threaded bung holes.

In another preferred embodiment of the invention the drum and pump connector further comprises a closure cap effective for providing a closure when the pump assembly is removed from the drum and pump connector.

In another preferred embodiment of the invention the drum and pump connector is formed from metal.

In another preferred embodiment of the invention the drum and pump connector is formed from plastic.

In another preferred embodiment of the invention the drum and pump connector comprises a drum size adapter for permitting the drum and pump connector to fit various diameter bung holes.

Another preferred embodiment of the invention is a drum and pump connector for attaching a pump having a cap with internal threads to a drum having a bung hole with internal threads, the drum and pump connector comprises a first cylindrical body and a second cylindrical body; the first cylindrical body is integral with the cap and the second cylindrical body having a threaded outer surface sized and adapted to mate with the internal threads of the bung hole.

### BRIEF DESCRIPTION OF THE DRAWINGS

These and other features, aspects, and advantages of the present invention will become better understood with regard to the following description, appended claims, and accompanying drawings where:

FIG. 1 is a side schematic illustration of the drum and pipe connector of the subject invention showing it attached to a drum and a pump assembly securely attached to the drum and pipe connector;

FIG. 2 is an exploded perspective illustration showing the drum and pipe connector and the cap of the pump apparatus of FIG. 1;

FIG. 3 is a perspective illustration of the drum and pump connector of FIG. 1 showing the second cylindrical body telescopically positioned within the first cylindrical body forming a seat effective for operating as an annular gasket between the drum and pump connector and the cap of the pump assembly, and showing the closure cap;

FIG. 4 is another preferred embodiment of the drum and pump connector integrally formed with the cap of the pump assembly; and

FIG. 5 is another preferred embodiment of the invention showing the drum and pump connector further comprising a drum size adapter.

### DETAILED DESCRIPTION OF THE INVENTION

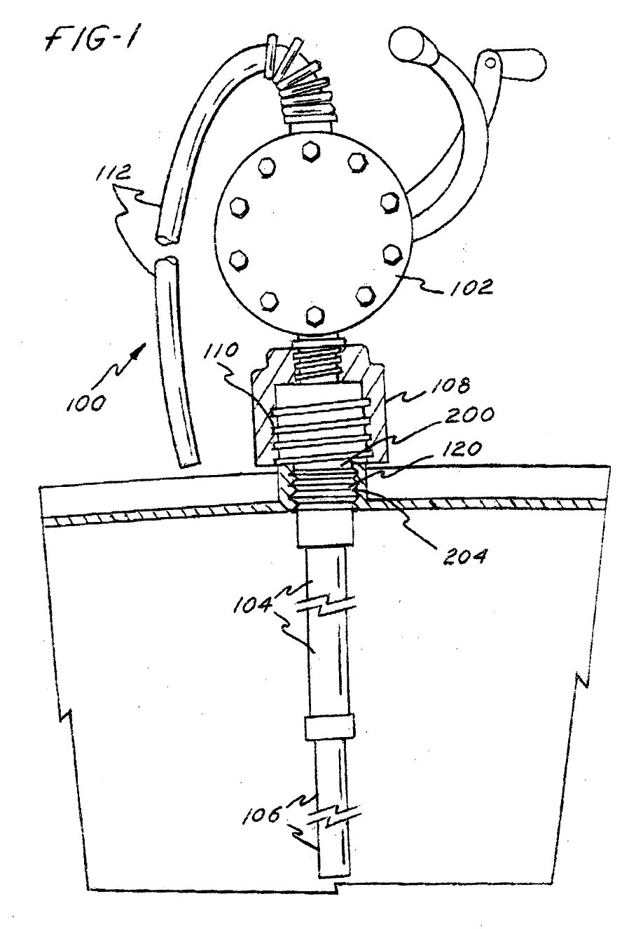

Referring to FIG. 1 a conventional pump assembly 100 is shown for use in removing liquid from a conventional drum, such as a conventional 55-gallon drum. In a preferred embodiment the pump assembly 100 includes a hand crank pump 102 having a base siphon tube 104 for inserting through the bung hole 200 of a drum 202. In a preferred embodiment, the base siphon tube 104 includes an extender 106 telescopically mounted within the base siphon tube 104 and adapted to move inwardly into the base siphon tube 104 or outwardly from the base siphon tube 104 to shorten or lengthen, respectively, the siphon tube 104 depending on the size of the drum 202. As shown the pump assembly 100 further includes a cap 108 having internal threads 110 and adapted to cover the contact area between the crank pump 102 and the bung hole 200 and an output hose 112 for inserting into another container, not shown, for receiving the liquid being discharged from the drum 202.

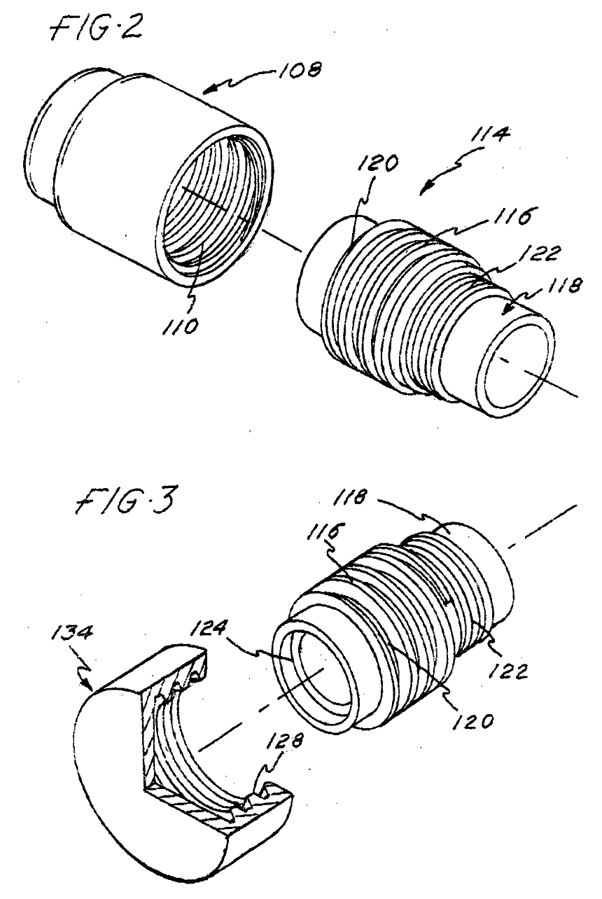

Referring to FIG. 2, a preferred embodiment of the invention is shown whereby the drum and pump connector 114 comprises a first cylindrical body 116 and a second cylindrical body 118 concentric with and longitudinally aligned with the first cylindrical body 116. The first cylindrical body 116 includes a threaded outer surface 120 that is sized and adapted to mate with the internal threads 110 of the cap 108. The second cylindrical body 118 also includes a threaded outer surface 122 that is sized and adapted to mate with the internal threads 204 (FIG. 1) of the bung hole 200 in the drum 202.

In operation, the user removes the bung plug (not shown) which is threadedly secured in the bung hole 202 by a threaded connection from the drum 202 and screws the second cylindrical body 118 using the threaded outer surface 122 into the bung hole 106 to form a secure threaded connection between the bung hole 200 and the drum and pump connector 114. The siphon tube 104 is properly lengthened to fit the particular drum 202 and the pump assembly 100 can then be mated with the first cylindrical body 116 of the drum and pump connector 114 by screwing the cap 108 of the pump assembly 100 such that the internal threads 110 of the cap 108 mates with the threaded outer surface 120 of the first cylindrical body 116. The output hose 112 can then be placed in the container (not shown) to receive the expelled liquid and the pump can be activated.

In another preferred embodiment of the invention, as shown in FIG. 3, the second cylindrical body 118 is telescopically positioned within the first cylindrical body 116 forming a seat 124 effective for operating as an annular gasket between the drum and pump connector 114 and the cap 108 of the pump assembly 100.

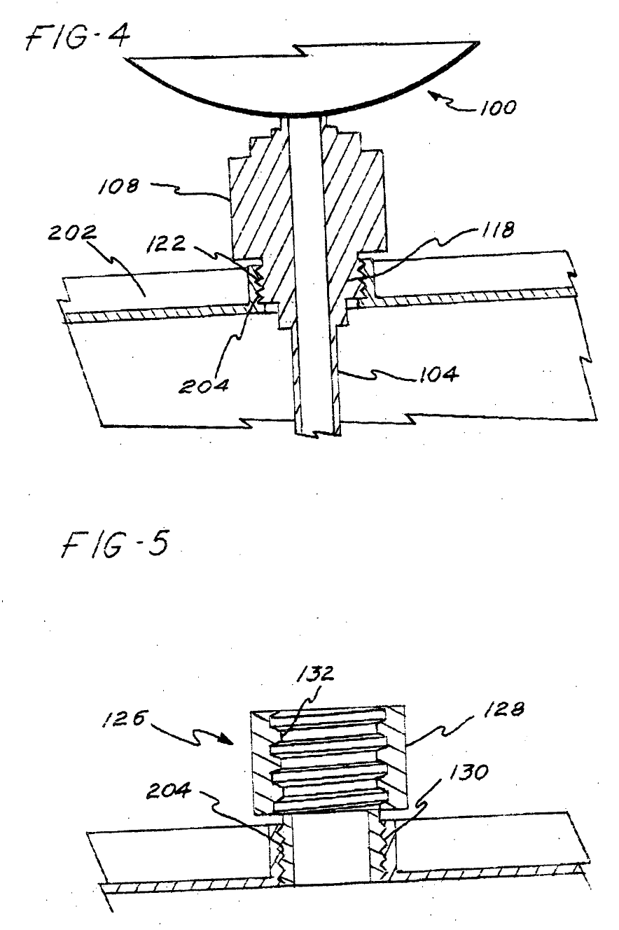

Referring to FIG. 4, another preferred embodiment of the invention is shown whereby the drum and pump connector 114 is integrally formed with the cap 108 of the pump assembly 100. The drum and pump connector 114 is provided with a second cylindrical body 118 includes a threaded outer surface 122 that is sized and adapted to mate with the internal threads 204 of the bung hole 200 in the drum 202. In this way, the pump assembly 100 can then be securely connected to the drum 202 by screwing the second cylindrical body 118 using the threaded outer surface 122 into the bung hole 106 to form a secure threaded connection between the bung hole 200 and the drum and pump connector 114.

In another preferred embodiment of the invention, as shown in FIG. 5 the drum and pump connector 114 includes a drum size adapter 126 comprising a cylindrical body 128 having a threaded outer surface 130 and a threaded inner surface 132. The threaded inner surface 132 is sized and adapted to mate with the threaded outer surface 120 of the second cylindrical body 118 and the threaded outer surface 130 of the drum size adapter 126 is sized and adapted to mate with the threads 204 of the bung hole 200. It should now be apparent that the size adapter is effective for permitting the drum and pump connector 114 of the subject invention to be easily adapted to mate with a variety of drums having different size and threaded bung holes.

In another preferred embodiment of the invention as shown in FIG. 3, the drum and pump connector 114 includes a closure cap 134, preferably formed from plastic or metal, having internal threads 136 sized and adapted to mate with the threaded outer surface 120 of the first cylindrical body 116. The closure cap 134 is effective for providing a closure when the pump assembly 100 is removed from the drum and pump connector 114 thereby preventing accidental spillage of the liquid contained within the drum 202, prevents contamination of the liquid during the time the pump assembly is not connected to the drum and pump connector.

It should be understood that the drum and pump connector 114 and the cap 108 may be formed from various materials, including metal and plastic.

It should also now be understood that the hand crank pump 102 of the pump assembly 100 can be replaced by an electric pump.

It should also now be apparent that the drum and pump connector of the present invention can be easily and quickly installed onto a conventional 55-gallon drum, or the like, and allow various type of pumps typically used to pump liquid out of drums, such as a Flo-Fast™ pump, such as sold by Product Development Group LLC, to be securely connected to the drum.

Accordingly, the drum and pump connector of the present invention is a new and novel apparatus for use in securely attaching a conventional pump assembly used for pumping liquid out of a drum connector that can be easily installed on a conventional drum, that permits a pump assembly to be mounted thereon during use and can be easily removed allowing the drum and pump connector to be capped until the pump assembly is reattached, and provides a seal between the drum and the pump assembly.

While the apparatus described constitute preferred embodiments of the invention, it is to be understood that the invention is not limited to the precise apparatus, and that changes may be made therein without departing from the scope of the invention which is defined in the appended claims.

We claim:

1. A drum and pump connector for attaching a pump having a cap with internal threads to a drum having a bung hole with internal threads, the drum and pump connector comprising:
a first cylindrical body and a second cylindrical body;
said first cylindrical body having a threaded outer surface sized and adapted to mate with the internal threads of the cap;
said second cylindrical body having a threaded outer surface sized and adapted to mate with the internal threads of the bung hole.

2. The drum and pump connector of claim 1 further comprising a drum size adapter effective for permitting the drum and pump connector to be easily adapted to mate with a variety of drums having different size and threaded bung holes.

3. The drum and pump connector of claim 1 further comprising a closure cap effective for providing a closure when the pump assembly is removed from the drum and pump connector.

4. The drum and pump connector of claim 1 wherein the drum and pump connector is formed from metal or plastic.

5. The drum and pump connector of claim 1 wherein said second cylindrical body is telescopically positioned within said first cylindrical body forming a seat effective for operating as an annular gasket between the drum and pump connector and the cap of the pump assembly.

6. A drum and pump connector for attaching a pump having a cap with internal threads to a drum having a bung hole with internal threads, the drum and pump connector comprising:
a first cylindrical body and a second cylindrical body;
said first cylindrical body is integral with the cap;
said second cylindrical body having a threaded outer surface sized and adapted to mate with the internal threads of the bung hole.

7. The drum and pump connector of claim 6 further comprising a drum size adapter effective for permitting the drum and pump connector to be easily adapted to mate with a variety of drums having different size and threaded bung holes.

8. The drum and pump connector of claim 6 further comprising a closure cap effective for providing a closure when the pump assembly is removed from the drum and pump connector.
